(19) United States
(12) Patent Application Publication
(10) Pub. No.: US 2014/0097393 A1
(43) Pub. Date: Apr. 10, 2014

(54) DROP TUBE TOOL

(71) Applicant: Ted Joseph Green, Somerset, OH (US)

(72) Inventor: Ted Joseph Green, Somerset, OH (US)

(21) Appl. No.: 14/044,214

(22) Filed: Oct. 2, 2013

Related U.S. Application Data
(60) Provisional application No. 61/710,130, filed on Oct. 5, 2012.

(51) Int. Cl. B66F 19/00

(52) U.S. Cl. CPC B66F 19/00
USPC 254/133 R

(57) ABSTRACT

A tool for gripping tubes from the inside includes an elongated rod with a gripping mechanism at one end. The gripping mechanism can be a scissor-jack-like mechanism that expands two or more gripping structures outwardly to seat against the tube sidewall. As the elongated rod is rotated relative to the gripping mechanism, the mechanism expands and forces the gripping structures against the tube's sidewall. A slide hammer and a ring can be used to displace the rod and tube, for example relative to another tube in which the first tube is frictionally held. A cutting mechanism can also be attached to the elongated rod or another rod to cut the tube, if necessary, from the inside.

### CROSS-REFERENCES TO RELATED APPLICATIONS

This application claims the benefit of U.S. Provisional Application No. 61/710,130 filed Oct. 5, 2012. The prior application is hereby incorporated by reference.

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

The invention relates generally to tools, and more particularly to a tool for gripping the inside of a first tube. Displacing the first tube relative to a second, coaxial tube in which the first tube is retained is also contemplated, as is cutting the first tube from the inside.

Fuel tanks in filling stations store fuel that is sold to customers in order to fill the tanks of the customers' vehicles. Conventional fuel tanks are stored beneath the surface of the ground upon which the vehicles drive into the station. These underground fuel tanks contain fuel that is pumped to the surface and then through a flexible hose to a nozzle that customers use to convey the fuel to their vehicle's tank. These underground storage tanks must be cleaned periodically to remove sediment and other contaminants.

As shown in FIG. 1, in a prior art underground fuel tank 2, a riser pipe 4 that is typically about four inches in diameter is rigidly mounted to the top of the fuel tank 2 and extends two to three feet to the top surface 6 of the ground beneath which the tank is buried. A removable drop tube 8 is inserted coaxially through the riser pipe 4 and extends to near the bottom of the tank, so that the tank can be filled with liquid 9 (such as gasoline, diesel fuel, kerosene, etc.) through the drop tube. The drop tube's outwardly facing surface is in a close-fitting relationship with the inwardly facing surface of the riser pipe to prevent significant penetration of contaminants into the tank. Thus, friction between the drop tube and the riser pipe not only prevents unintended relative movement between the two, but also provides a seal of sorts to prevent contamination of the underground fuel tank.

When it is necessary to clean the tank, the drop tube is withdrawn from the riser pipe to provide better access to the tank and to avoid damage to the drop tube during cleaning. The drop tube and riser pipe can be made of different metals, which can result in galvanic corrosion. Furthermore, if the drop tube has been in the riser pipe for a long time without being removed, a significant amount of residue builds up between them due to exposure to outdoor elements. Thus, it is often very difficult to remove the drop tube without damaging or destroying both the drop tube and the riser pipe.

In any situation in which two thin-walled pipes are in a high-friction, coaxial relationship, there can be difficulties removing one pipe from the other. The need therefore exists for a tool that can remove a first tube from an opening without damaging either or both tubes, even when there is high resistance to relative movement between the two.

### BRIEF SUMMARY OF THE INVENTION

The invention is a tool used to expand gripping surfaces outwardly to contact and grip the inside of a tube. By mounting the tool to the inner tube, movement of the tool allows any inner tube, whether it is an underground fuel tank drop tube or other structure, to be moved along its length relative to any outer tube, whether it is an underground fuel tank riser pipe or other structure. This permits removal of the inner tube with minimal damage to the inner and outer tubes.

A scissor jack mechanism is an example of an expanding and contracting mechanism that is used with at least two gripping structures that seat against the drop tube's inwardly facing surface. The scissor jack mechanism threadingly receives a rod and the gripping structures move relative to one another when the threaded shaft of the rod is rotated. The gripping structures are pivotably mounted to the scissor jack mechanism, and have sharpened pins extending radially outwardly therefrom, or any other gripping surface that will prevent significant slipping between the gripping structures and the drop tube during use.

Various means can be used to grip the inner tube, and some contemplated gripping means include roughened surfaces, such as files. Other structures contemplated include pins that can concentrate the expanding force at one or more points, or pierce the inner tube if the tube material is strong enough to withstand subsequent forces applied. Still other gripping means include high friction materials, such as rubber and other elastomers, as well as adhesives, including tacky materials.

### BRIEF DESCRIPTION OF THE SEVERAL VIEWS OF THE DRAWINGS

FIG. 1 is a schematic view in section illustrating a prior art underground fuel tank showing the components thereof.

FIG. 2 is a side view illustrating a preferred embodiment of the present invention.

FIG. 3 is a magnified side view illustrating the preferred gripping mechanism in greater detail than shown in FIG. 2.

FIG. 4 is an end view in perspective illustrating the preferred gripping mechanism of FIG. 2.

FIG. 5 is a top view in perspective illustrating the preferred gripping mechanism of FIG. 2.

FIG. 6 is a bottom view in perspective illustrating the preferred gripping mechanism of FIG. 2.

FIG. 7 is a top view in perspective illustrating an alternative embodiment of the present invention being inserted into a tubular structure.

FIG. 8 is a side view illustrating a cutter mounted to an elongated rod.

FIG. 9 is a side view in perspective illustrating the cutter of FIG. 8.

FIG. 10 is a view in perspective illustrating the cutter of FIG. 10 separated from the elongated rod.

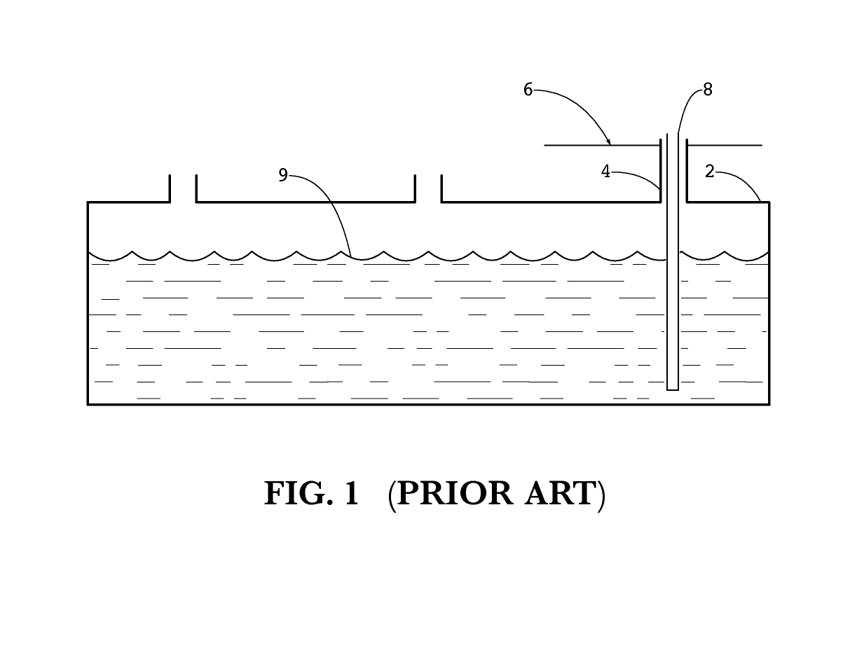

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 61/710,130 filed Oct. 5, 2012 is incorporated in this application by reference.

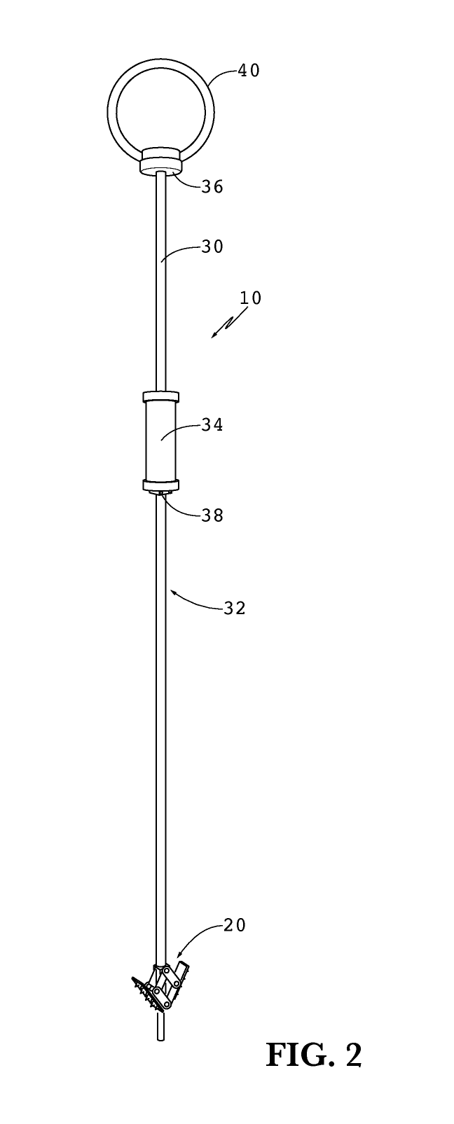

As shown in FIG. 2, the tool 10 includes a gripping mechanism 20 preferably mounted to the lower end of an elongated structure that a person can grip, such as the rod 30. The elongated rod 30 can be extended into the passage of a tube that is a few inches in diameter. A handle 32, which can be contoured and protective, is formed along the rod 30 as shown in FIG. 2. A person can readily grasp and hold the handle 32 with a human hand while operating the tool 10. Thus, the tool 10 can be hand-held and the lower end, which includes the gripping mechanism 20, can be inserted into the opening of a tube, such as the drop tube 8 of an underground fuel storage tank.

Preferably above the handle 32, a slide hammer 34 is slidably mounted between the hammer stop 36, which is designed to absorb significant impact from upward movement of the hammer 34, and the stop collar 38, which is designed to prevent the slide hammer from progressing downwardly along the rod to the handle 32. When the slide hammer 34 is moved upwardly along the rod 30, the slide hammer 34 impacts and applies a sharp force to the hammer stop 36, which is transferred to the rod 30. Such an upward force applied to the rod is transferred to the drop tube through the gripping mechanism 20 as described in more detail below.

A ring 40 is mounted at or near the top of the rod 30 above the hammer stop 36. The ring 40 allows the tool to be hung on a peg or other structure when not in use, it allows a crane or other lifting means to forcibly lift the entire tool and any attached structure, and it extends outwardly from the rod 30 sufficiently to provide leverage to rotate the rod 30 about the rod's longitudinal axis. Any other structure that permits the tool 10 to be attached to, and raised by, a machine to aid in the removal of a drop tube or other structure, is contemplated for mounting on the top of the tool 10. Thus, a hook, one portion of any fastener or any other attachment structure can be substituted for the ring 40. Likewise, any leverage structure can be attached to the rod 30, such as near the handle 32.

The gripping mechanism 20, which is preferably mounted to the lower end of the rod 30, preferably mounts on the helical threads of a threaded rod at the end of the rod 30 to expand and contract the diameter of the gripping surfaces. In general, the gripping mechanism 20 contains an expanding and contracting mechanism, along with at least two, but possibly more, gripping structures to grip the inner sidewall of the drop tube. Thus, when the tool 10 is lowered into the top of the drop tube with the gripping mechanism 20 at the lower end, the expanding and contracting mechanism is used to expand the gripping structures into the inwardly facing wall of the drop tube, and the gripping structures grip the wall of the drop tube so the entire tool 10 and drop tube can be removed as a unit. This can be accomplished with a crane using the ring 40, or it can be accomplished by hand using the slide hammer 34.

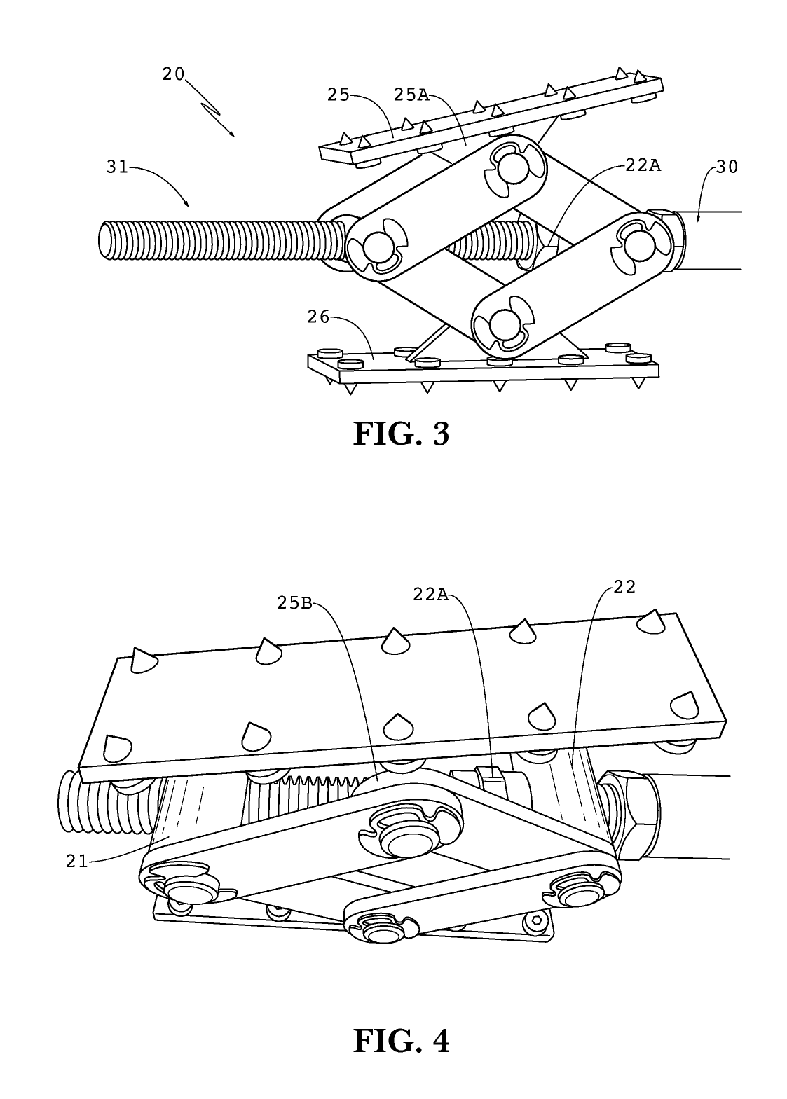

In particular, one end of a threaded rod 31 extends, as an extension of the rod 30, through the component parts of the gripping mechanism 20 as shown in FIGS. 3, 4, 5 and 6. This permits removal and replacement of the gripping mechanism 20. The opposite end of the threaded rod 31 is capped to prevent damage to the threads if dropped onto a hard surface.

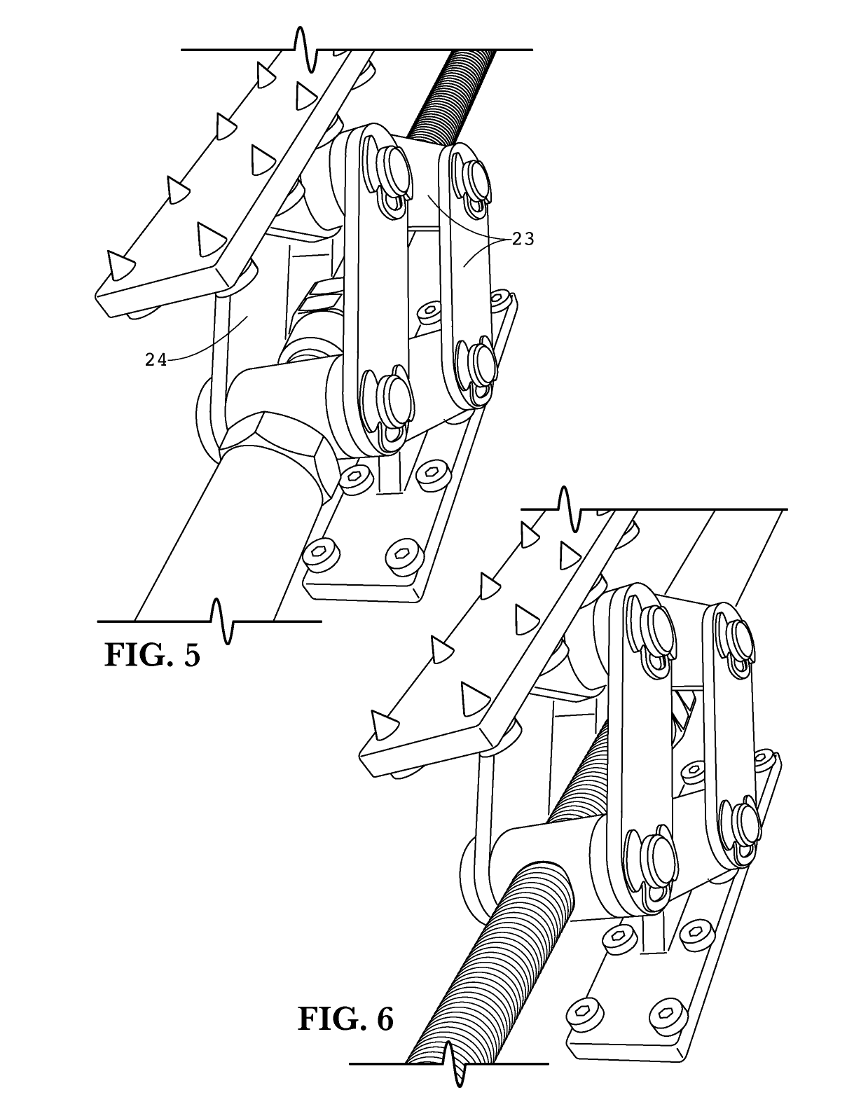

As shown in FIG. 4, a follower rod 21 and an idler rod 22 receive the threaded rod 31 as shown in FIG. 5. The follower rod 21 has a transverse threaded opening through which the threaded rod 31 extends in order to be moved along the length of the threaded rod by rotation of the threaded rod 31 relative to the follower rod 21. The idler rod 22 has a transverse smooth opening through which the threaded rod 31 extends, and the threaded rod 31 can rotate through the opening without moving the idler rod 22 along the length of the threaded rod 31. A threaded jam-nut 22a is mounted to the helical threads of the threaded rod 31 between the follower rod 21 and the idler rod 22, as shown in FIGS. 3 and 4. This jam-nut 22a does not rotate relative to the threaded rod 31, and prevents the idler rod 22 from moving a significant distance from the elongated end of the rod 30. Thus, upon rotation of the threaded rod 31, the follower rod 21 moves in one direction along the threaded rod's length relative to the idler rod 22, and the idler rod 22 does not move along the threaded rod's length a significant distance from the end of the rod 30. This relative movement of the rods 21 and 22 causes expansion or contraction of the gripping mechanism 20.

As best viewed in FIG. 5, the parallelogram members 23 and 24 are rotatably mounted on opposite ends of the follower rod 21 and idler rod 22. The parallelogram members 23 and 24 are also rotatably mounted to the gripping structures 25 and 26. The web 25a extends from rigid attachment to the gripping structure (see FIG. 3) and a rod 25b (FIG. 4) to which the web 25a rigidly attaches. The gripping structure 25 is described, and a similar structure is formed (but not shown or described separately) for the gripping structure 26.

Upon rotation of the threaded rod 31, the follower rod 21 moves in one direction along the threaded rod's length relative to the substantially stationary idler rod 22. This relative movement changes the angles of the components of each of the parallelogram members 23 and 24 in the manner of a scissor jack, thereby forcing the gripping structures 25 and 26 farther apart or closer together, depending upon the rotation direction of the threaded rod. This movement provides the widening or narrowing gripping mechanism 20, depending on the direction of rotation of the threaded rod 31, at the end of the tool 10.

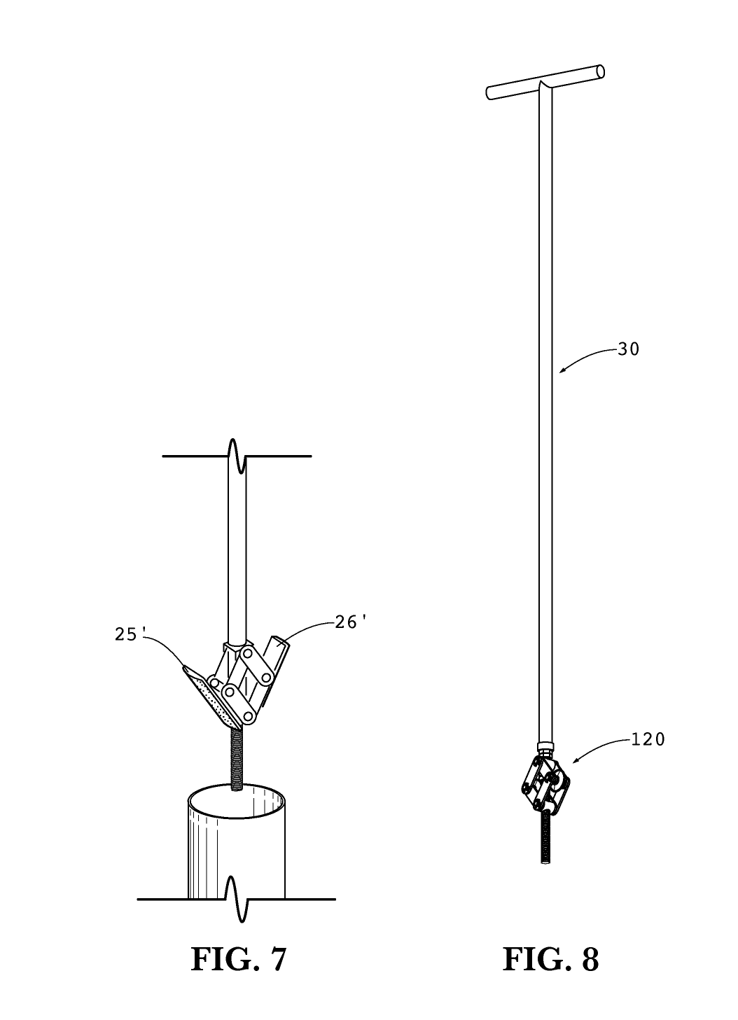

The gripping structures 25 and 26 mounted to the gripping mechanism 20 can have one or different gripping features that allows them to seat against and prevent or mitigate movement of the gripping mechanism 20 relative to the drop tube. In one embodiment, the gripping structures include knurled metal, in the manner of metal files 25′ and 26′ (as shown in FIG. 7) used for filing wood or metal, which dig into the inside of the tube by virtue of the roughened and/or sharpened pattern of the surface texture. A knurled metal may be obtained from a metal file, which can be copper-based (e.g., beryllium copper) or stainless steel in order to avoid sparking when striking steel, which riser tubes are commonly made of. Alternatively, the gripping structures can be rubber or other material that has a high static and/or dynamic coefficient of friction when seated against common drop tube materials. Still further, the gripping structures can be formed using an adhesive that adheres to, or is tacky and tends to chemically bond to, the inside of the tube. Furthermore, the gripping structure can be sharpened pins extending through plates as shown in the illustrations of FIGS. 2-6. In FIG. 7, the gripping structure embodiment showing the roughened texture is illustrated. As noted above, there can be three, four, five or more gripping structures, as will become apparent to the person of ordinary skill.

The gripping mechanism 20 is inserted lengthwise into a drop tube (as shown in FIG. 7) with at least the ring 40 remaining outside. It is preferred that the diameter of the ring 40 is substantially greater than the inner diameter of the drop tube and/or the riser pipe to prevent the tool 10 from falling into the tank if grip is lost and the tool 10 falls toward the drop tube. In such a situation, the ring 40 would impact the top of the drop tube and halt any further progression of the tool 10 into the drop tube.

In use, the lower end of the tool 10 is inserted into the drop tube as shown in FIG. 7 with at least most of the gripping mechanism 20 disposed within the drop tube. The gripping structures 25 and 26 are then forced by the gripping mechanism 20 against the radially inwardly facing surfaces of the drop tube by grasping the ring 40, for example, and rotating the upper portion of the tool 10, including the threaded shaft 31, relative to the gripping mechanism 20. This may be accomplished by hand-rotating the gripping mechanism 20 about the threaded shaft 31 until the gripping structures contact the drop tube, and then by rotating the threaded shaft 31 relative to the gripping mechanism 20 using the handle 32 and/or the ring 40. This action expands the gripping mechanism 20 further and forces the gripping structures 25 and 26 firmly against the radially inwardly facing surface of the drop tube.

Once the pins or other gripping surfaces of the gripping mechanism 20 are seated against the radially inwardly facing surfaces of the drop tube sufficiently to prevent or minimize any relative movement between the pins and the drop tube, the user grips the handle 32 and/or the rod 30 to apply a longitudinal, upwardly-directed force against the tool 10 (and thereby, the drop tube) to remove the drop tube from the riser pipe. If this does not sufficiently move the drop tube, the slide hammer 34 can be rapidly slid upwardly along the length of the rod 30 from the handle 32 toward the ring 40, thereby impacting the hammer stop 36 that is rigidly mounted to the rod 30. This imparts a very sharp impact to the rod 30 and attached gripping mechanism 20, thereby jarring the drop tube loose from the riser pipe. A crane or other lifting mechanism can also be used to raise the tool 10, such as by attaching a cable with a hook to the ring 40 and lifting.

If the drop tube will not move relative to the riser pipe, the rod 30 can be rotated relative to the gripping mechanism 20 in order to contract the gripping mechanism 20 and remove the tool 10 from the drop tube. Then a second tool, or a modified version of the tool 10, can be used to cut the drop tube. The modified version of the tool 10 will be described below as the tool 10 with the gripping mechanism 20 removed and a cutting mechanism 120 mounted in the place of the gripping mechanism. Nevertheless, it is understood that two separate tools may be constructed instead of, or in addition to, the more advantageous and described tool 10 with a removable cutting mechanism 120 and a removable gripping mechanism 20.

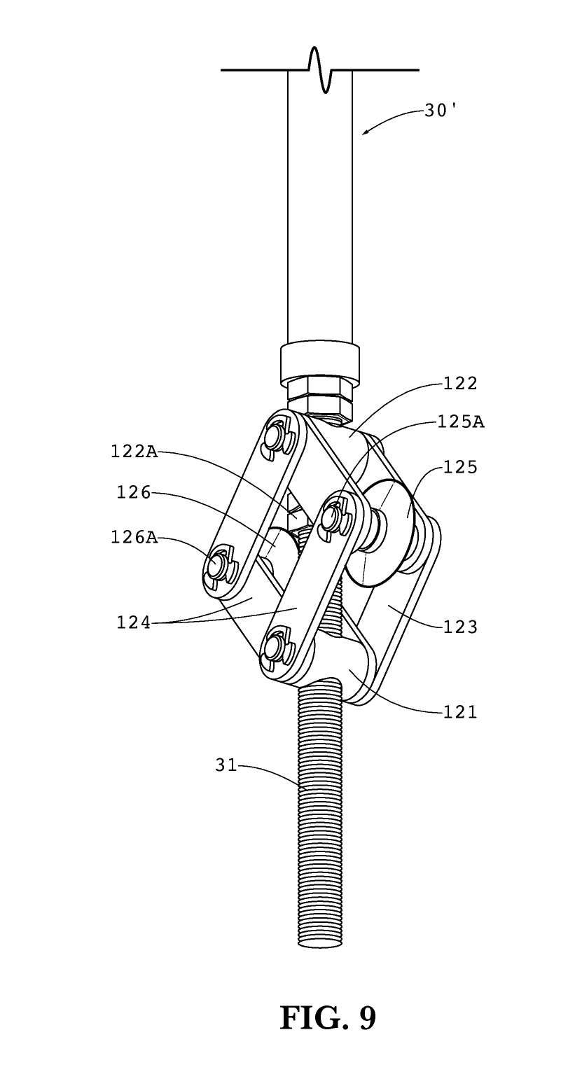

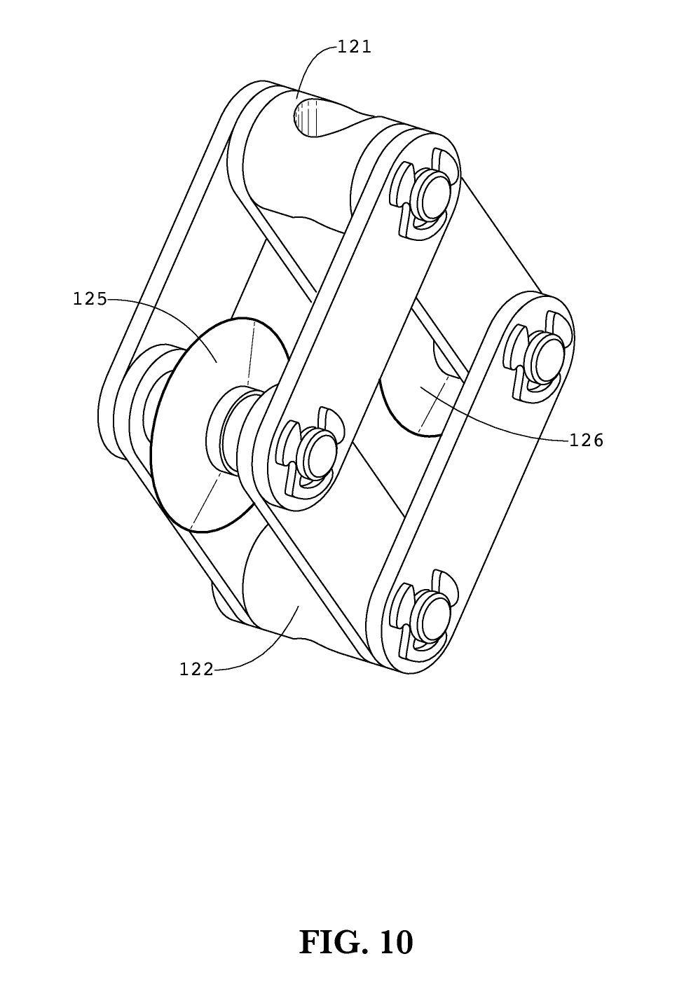

In the preferred embodiment, the gripping mechanism 20 is removed by loosening the jam-nut 22a and then rotating the entire gripping mechanism 20 and jam nut 22a until they are both removed from the threaded rod 31. Next, a cutter, such as the cutting mechanism 120 shown in FIGS. 8, 9 and 10, replaces the gripping mechanism 20 by installing the cutting mechanism 120 on the threaded rod 31. The cutting mechanism 120 is shown in FIG. 8 mounted to the rod 30′, which differs slightly from the rod 30 in that it has no slide hammer for reasons that will become apparent to a person having ordinary skill. As shown in FIG. 9, the cutting mechanism 120 is mounted onto the threaded shaft 31 in the same way the gripping mechanism 20 was mounted on the threaded shaft 31. Thus, the threaded rod 31 is threaded through the follower rod 121 and extends slidably through the idler rod 122 with the jam nut 122a mounted on the shaft 31 to prevent significant longitudinal movement of the idler rod 122 relative to the threaded shaft 31.

As shown in FIG. 9, a follower rod 121 and an idler rod 122 receive the threaded rod 31. The follower rod 121 has a transverse threaded opening through which the helical threads of the threaded rod 31 extend in order to be moved along the length of the threaded rod by rotation of the threaded rod 31 relative to the follower rod 121. The idler rod 122 has a transverse, smooth opening through which the threaded rod 31 extends, and the threaded rod 31 can rotate through the opening without moving the idler rod 122 along the length of the threaded rod 31. A threaded jam-nut 122a is mounted to the threaded rod 31 between the follower rod 121 and the idler rod 122, as shown in FIG. 9. This jam-nut does not rotate relative to the threaded rod 31, and prevents the idler rod 122 from moving a significant distance from the end of the rod 30. Thus, upon rotation of the threaded rod 31, the follower rod 121 moves in one direction along the threaded rod's length relative to the idler rod 122, and the idler rod 122 does not move along the threaded rod's length a significant distance from the end of the rod 31.

As best viewed in FIG. 9, the parallelogram members 123 and 124 are rotatably mounted on opposite ends of the follower rod 121 and idler rod 122. The cutting wheels 125 and 126, which are preferably sharp disks, are rotatably mounted to the parallelogram members 123 and 124 on the ends of respective rods 125a and 126a. The cutting wheels 125 and 126 extend radially outwardly from the threaded rod 31 farther than any structure, so that upon rotation of the threaded rod 31, the follower rod 121 moves in one direction along the threaded rod's length relative to the substantially stationary idler rod 122. This relative movement changes the angles of the components of each of the parallelogram members 123 and 124 in the manner of a scissor jack, thereby forcing the cutting wheels 125 and 126 farther apart or closer together, depending upon the rotational direction of the threaded rod. This movement provides the widening or narrowing cutting mechanism 120, depending on the direction of rotation of the threaded rod 31, at the end of the tool 10.

The cutting wheels 125 and 126 mounted to the cutting mechanism 120 can have one or different cutting features that allows them to seat against and cut from the inside of the drop tube. In one embodiment, the cutting wheels 125 and 126 are made of stainless steel with a sharp peripheral edge and a thicker central aperture through which a bearing is inserted for smooth rotation about the axle formed by the rods 125a and 126a. Alternatively, the cutting wheels can be made of other materials or configurations that cut the inside of the drop tube. In one embodiment, one wheel is a cutting wheel, and the other is a dull rolling wheel that does not cut the drop tube. Nevertheless, both wheels roll along the drop tube's inner surface.

The cutting mechanism 120 is inserted lengthwise into a drop tube with at least the ring 40 remaining outside. The cutting wheels 125 and 126 are then forced by the cutting mechanism 120 against the radially inwardly facing surfaces of the drop tube by rotating the upper portion of the tool 10, including the threaded shaft 31, relative to the cutting mechanism 120. This may be accomplished by hand-rotating the cutting mechanism 120 about the threaded shaft 31 until the cutting wheels contact the drop tube, and then by rotating the threaded shaft 31 relative to the cutting mechanism 120 using the handle 32 and/or the radially-extending ring 40. This action expands the cutting mechanism 120 further and forces the cutting wheels 125 and 126 firmly against the radially inwardly facing surface of the drop tube.

Once the cutting wheels are seated against the radially inwardly facing surfaces of the drop tube sufficiently, the user grips the handle 32 and/or the rod 30 to apply a longitudinal, upwardly-directed force against the tool 10, which causes the cutting wheels to roll against the inwardly facing surface of the drop tube. If there is sufficient force applied by the cutting mechanism 120, two longitudinal grooves are formed by the cutting wheels where the cutting wheels roll against the drop tube. Upon reaching the upper limits of the drop tube, the threaded rod 31 is rotated further to further expand the distance between the cutting wheels, which causes further groove formation in the drop tube. The tool 10 is then forced downwardly to cause the cutting wheels to re-trace the same groove they followed in the first movement, but causing a deeper groove as the cutting wheels slice into the drop tube. This process is repeated until the cutting wheels cut far enough through the drop tube to permit the drop tube to be peeled inwardly away from the riser tube for easier removal. The tool 10 is rotated to contract the cutting mechanism 120 and the tool 10 is withdrawn from the drop tube. Next, the drop tube is peeled away from the riser tube.

In an alternative embodiment, one of the cutting wheels is replaced by a rubber or other high-friction material wheel so that only one groove is formed in the drop tube by a single cutting wheel, and the opposing wheel merely rolls against the drop tube. This may be advantageous if it is difficult to maintain multiple wheels in their grooves. Regardless of how many cutting wheels are used, one groove is formed by each cutter.

The cutting mechanism 120 slices the drop tube longitudinally on one or two opposing sides of the inwardly facing surface of the drop tube. The cutting wheels are placed deep into, and against the radially inwardly facing surface of, the drop tube. The handle and the rod are rotated to rotate the threaded shaft and, thereby, expand the scissor mechanism to apply a strong force on the cutting wheels against the inner surface of the pipe. The handle and shaft are then pulled longitudinally to move the cutting wheels against the drop tube's radially inwardly facing surface along lines aligned with the length of the tube. The pulling is stopped when the cutting wheels are at or near the end of the drop tube, and the handle and shaft are rotated to further expand the scissor mechanism, thereby pushing the cutting wheels outwardly further into the drop tube wall. Then the handle/shaft is pushed into the drop tube along the same path in the opposite direction, thereby making deeper cuts than during the withdrawal step. This process of expanding and then changing directions is repeated until the drop tube is cut completely through along both paths the cutting wheels follow. This permits the drop tube to be peeled inwardly. Thus, the drop tube can be removed without destroying the riser pipe.

It should be noted that the length of the tool can be modified, such as by extensions added to the length of the rod, or by extending the rod in the manner of a telescope. Furthermore, all components of the tool are made of non-sparking materials, such as stainless steel (other than the cutting wheel, which is tool steel) unless noted otherwise.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A tool for gripping the inside of a tube, the tool comprising:
(a) an elongated rod with a first end and a second end; and
(b) a gripping mechanism mounted to the rod near the second end, the gripping mechanism including an expander having at least first and second gripping structures facing radially outwardly from the rod, wherein the expander moves the first and second gripping structures radially outwardly upon rotation of the elongated rod relative to the gripping mechanism in a first direction, and radially inwardly upon rotation of the elongated rod relative to the gripping mechanism in a second, opposite direction.

2. A tool for gripping the inside of a tube, the tool comprising:
(a) an elongated rod with a first end and a second, opposite end;
(b) helical threads on the second end of the elongated rod;
(c) a gripping mechanism including:
(i) a first transverse rod with a threaded aperture threadably mounted to the helical threads;
(ii) a second transverse rod with an aperture through which the second end of the elongated rod extends; and
(iii) at least first and second gripping structures linked to the transverse rods and facing radially outwardly from the elongated rod, wherein the gripping structures are configured to move radially outwardly upon rotation of the elongated rod relative to the gripping mechanism in a first direction, and the gripping structures are configured to move radially inwardly upon rotation of the elongated rod relative to the gripping mechanism in a second, opposite direction; and
(d) a body extending radially outwardly from the elongated rod, spaced from the gripping mechanism, to provide leverage to enable a user to rotate the elongated rod relative to the gripping mechanism.

3. A tool for gripping the inside of a tube and then cutting the tube, the tool comprising:
(a) an elongated rod with a first end and a second, opposite end;
(b) helical threads on the second end of the elongated rod;
(c) a gripping mechanism including:
(i) a first transverse rod with a threaded aperture configured to threadably mount to the helical threads;
(ii) a second transverse rod with an aperture through which the second end of the elongated rod is configured to extend; and
(iii) at least first and second gripping structures facing radially outwardly from the elongated rod, wherein the gripping structures are configured to move radially outwardly upon rotation of the elongated rod relative to the gripping mechanism in a first direction, and the gripping structures are configured to move radially inwardly upon rotation of the elongated rod relative to the gripping mechanism in a second, opposite direction;
(d) a body extending radially outwardly from the elongated rod, spaced from the gripping mechanism, to provide leverage to enable a user to rotate the elongated rod relative to the gripping mechanism; and
(e) a cutter including:
(i) a third transverse rod with a threaded aperture configured to threadably mount to the helical threads;
(ii) a fourth transverse rod with an aperture through which the second end of the elongated rod is configured to extend; and
(iii) at least a cutter and a roller facing radially outwardly from the elongated rod, wherein the cutter and roller are configured to move radially outwardly upon rotation of the elongated rod relative to the cutter in a first direction, and the cutter and roller are configured to move radially inwardly upon rotation of the elongated rod relative to the cutter in a second, opposite direction.

4. A method for gripping the inside of a tube and moving the tube, the method comprising:
(a) disposing an elongated rod, having opposing first and second ends, with the second end adjacent the tube;
(b) mounting a gripping mechanism to the rod near the second end, the gripping mechanism including an expander having at least first and second gripping structures facing radially outwardly from the rod;
(c) extending at least the gripping mechanism into the tube;
(d) while the gripping mechanism is in the tube, expanding at least first and second gripping structures on the gripping mechanism radially outwardly and seating said at least first and second gripping structures firmly against radially inwardly facing surfaces of the tube; and
(e) displacing the elongated rod, thereby displacing the tube.

5. The method in accordance with claim 4, wherein the step of expanding further comprises rotating the elongated rod relative to the gripping mechanism in a first direction.

6. The method in accordance with claim 5, further comprising the step of rotating the elongated rod relative to the gripping mechanism in a second direction, thereby moving the gripping structures radially inwardly.

7. A method for cutting a tube, the method comprising:
(a) disposing an elongated rod, having opposing first and second ends, with the second end adjacent the tube;
(b) mounting a cutter to the rod near the second end, the cutter including at least one cutting wheel and a rolling wheel facing radially outwardly from the rod;
(c) extending at least the cutter into the tube;
(d) while the cutter is in the tube, expanding said cutting wheel and said rolling wheel on the cutter radially outwardly and seating said cutting wheel and said rolling wheel firmly against radially inwardly facing surfaces of the tube; and
(e) displacing the elongated rod in a first direction along the elongated rod's axis, thereby cutting into the tube with at least the cutting wheel.

8. The method in accordance with claim 7, further comprising further expanding said cutting wheel and said rolling wheel on the cutter radially outwardly and subsequently displacing the elongated rod in a second, opposite direction along the elongated rod's axis, thereby cutting into the tube with at least the cutting wheel.

9. The method in accordance with claim 8, wherein the step of expanding further comprises rotating the elongated rod relative to the cutter in a first direction.

10. The method in accordance with claim 9, further comprising the step of rotating the elongated rod relative to the cutter in a second direction, thereby moving the cutter and the rolling wheel radially inwardly.

11. The method in accordance with claim 7, wherein the rolling wheel is a second cutting wheel.
